(19) United States
(12) Patent Application Publication
(10) Pub. No.: US 2016/0128907 A1
(43) Pub. Date: May 12, 2016

(54) DISPOSABLE SPITTOON COVER

(71) Applicant: Ken Bagdasarian, Whittier, CA (US)

(72) Inventor: Ken Bagdasarian, Whittier, CA (US)

(21) Appl. No.: 14/537,887

(22) Filed: Nov. 10, 2014

(51) Int. Cl. A61J 19/00

(52) U.S. Cl. CPC A61J 19/00; A61J 2200/60

(57) ABSTRACT

A disposable spittoon cover for a paper cup or the like includes a conical tunnel with an entry hole near or at an apex of the tunnel, and an integral, resilient flap covering the entry hole. The flap may be formed at a slight angle to the tunnel walls, in the range of about 5° to 20°. The disposable cover may further include two or more concentric grooves configured for fitting snugly to rims of disposable cups, with each of the grooves configured to fit to a cup of different diameter. The grooves may be separated and spaced apart from one another in a direct transverse to a plane defined by any one of the circular grooves (e.g., a “vertical” direction), by one or more interposed annular ring walls.

### FIELD

The present disclosure relates to disposable covers, including disposable covers for disposable liquid or semi-liquid waste receptacles, such as spittoons.

### BACKGROUND

Spittoons are referenced in 19-century and earlier writings as a fairly commonplace item in households, offices, and other social settings. The widespread adoption of modern plumbing and changes in social behavior have reduced but not eliminated public demand for spittoons. Unlike traditional spittoons, many modern spittoons are not cleaned and reused. Instead, disposable containers such as paper cups are used as spittoons, and discarded after use. Dental offices have retained spittoons, typically plumbed with drains and running water to immediately flush waste liquids. Stand-alone, portable spittoons are still sold for use in bars, at certain other events where tobacco chewing is prevalent, for wine-tasting venues, hospitals or health care facilities, and for other niche markets.

Problems with disposable spittoons include maintaining an attractive appearance during use, controlling odors, and preventing spills. Besides being unappealing, waste liquids contained in the spittoon may pose a biologic hazard. Therefore, it is important to protect workers handling a used spittoon from contact with contained wastes. It may also be important in some contexts to prevent any spreading of hazard from a liquid waste by insect vectors. Open paper cups are not designed to control these problems, and consequently are not optimal for use as spittoons. Disposable spittoon covers have been developed to better control spills, but do not adequately resolve more demanding problems of disposable spittoons such as controlling odors, maintaining an attractive appearance, or discouraging insects. In addition, existing covers are only able to fit one size of paper cup, and therefore place more demands on the end user to stock the proper matching sizes of cups and covers.

It would be desirable, therefore, to make improvements in a disposable spittoon cover for overcoming all of the aforementioned limitations. At the same time, it is also desirable to preserve the advantages of low cost and disposability afforded by disposable spittoon covers. Solutions for these and other limitations of prior art spittoon covers are presented in the specification that follows.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect of the disclosure, a disposable spittoon cover or a lid for a container, may consist essentially of a contoured, resilient sheet material of one piece having contours defining various cooperating components. These components may include a circular groove disposed around and adjacent to a circular periphery of the sheet material, which groove is concave towards a first side of the sheet material, intended to fit snugly over the rim of a disposable cup. The components may further include a cone-shaped (conical) tunnel, disposed at a circular center of the sheet material, having an open conical base oriented towards a second side of the sheet material opposite to the first side. That is, the open conical base of the tunnel faces upwards to receive waste fluids when the cover is fit on to a disposable cup. The components may further include a flap over a conical vertex of the conical tunnel, the flap defined by a perimeter cut through a lateral surface wall of the cone-shaped tunnel and joined to the lateral surface wall by a resilient hinge piece. The flap operates to admit fluids into an attached cup, but otherwise remains closed during use to maintain a more attractive appearance, control odors, and reduce access by insects.

In other aspects, the contours of the cover may further define an annular wall extending between and around the open conical base of the cone-shaped tunnel and the circular groove, providing substantial vertical separation between the base and the groove. The circular groove may have a cross-section contoured for fitting over a bead around a rim of a container, such as a disposable cup. For example, the cross-section may be generally semi-circular and narrowed at an open end thereof. The contours of the cover may further define one or more additional circular grooves disposed between the circular periphery of the sheet material and the circular groove, each configured for fitting a cup of different diameter than other ones of the grooves. In an embodiment, one of the additional circular grooves runs around the open conical base of the tunnel, positioned at the terminus of the conical base. A second one of the additional circular grooves may be disposed in the annular wall intermediate between the groove positioned at the terminus of the conical base and the circular groove adjacent to the periphery of the cover.

In other aspects, the flap may be biased away from the circular center of the sheet material, where the apex of the conical tunnel lies. The flap may include a substantially planar body joined to the hinge. The substantially planar body of the flap may be generally elliptical in shape, and oriented obliquely to a conical base defined by the conical tunnel. The flap and hinge may be formed by cutting with a die from the wall of the conical tunnel. The flap is operative to admit, under influence of gravity, a fluid deposited in the cone-shaped tunnel through an opening in the sheet material formed by the perimeter cut of the flap. The bias in position of the flap along with its oblique angle relative to the base of the cone may facilitate its function for admitting fluids.

In other aspects, the sheet material may consist essentially of an organic polymer material. The organic polymer material may be characterized by a uniform thickness on the range of 0.004 to 0.040 inches. The organic polymer material may be, or may include, any one or more of a polystyrene, polyvinylchloride, or polyethylene material. In alternative embodiments, the sheet material may comprise a paper or cardboard material, for example, waxed cardstock.

A more general-purpose cover may also incorporate a multi-groove feature similar to that used on the spittoon cover. For example, a cover for a container, consisting essentially of a contoured, resilient sheet material of one piece may include contours defining a first circular groove disposed around and adjacent to a circular periphery of the sheet material, the first circular groove having a first diameter and being concave towards a first side of the sheet material configured for fitting snugly over a rim of a disposable cup of matching diameter. The contours may further define a second circular groove disposed in the sheet material concentric to the first circular groove, the second circular groove having a second diameter smaller than the first diameter and being concave towards the first side of the sheet material configured for fitting snugly over a rim of a disposable cup of matching diameter. The contours may further define a cover comprised of the sheet matter closing an interior of the second circular groove.

Further aspects of the general purpose multi-groove cover may include an annular wall formed in the sheet material and interposed between first circular groove and the second circular groove, thereby spacing the first circular groove apart from the second circular groove in a direction perpendicular to a plane defined by the first circular groove. The cover may be contoured in one of various configurations, for example, a dome concave towards the first side of the sheet material or a flat sheet. A third circular groove may disposed in the sheet material concentric to and inward of the first circular groove The third circular groove may have a third diameter smaller than the first diameter and larger than the second diameter. Like the first and second grooves, the third groove may be concave towards the first side of the sheet material configured for fitting snugly over a rim of a disposable cup of matching diameter.

A disposable spittoon may be provided by covering a disposable cup having a top opening defined by a sidewall, the sidewall connected to a circular bottom of the cup, with a disposable spittoon cover as described herein. The disposable cup may be, for example, a paper cup, a plastic cup, or an expanded polystyrene cup.

The foregoing summary provides an overview and selected details of disposable spittoon cover and applications there for. Further aspects and details of the disposable spittoon cover are provided in the detailed description that follows. The drawings accompanying the written disclosure will first be described briefly.

### BRIEF DESCRIPTION OF THE DRAWINGS

The drawings described herein are for illustrative purposes and are not intended to limit the scope of the present disclosure. Like element numerals may be used to indicate like elements appearing in one or more of the figures.

FIG. 1 is a side view showing an example of a disposable spittoon cover with a multi-groove feature for fitting different sizes of paper cup and a resilient entry flap.

FIG. 2A is a sectional side view of the disposable spittoon cover shown in FIG. 1.

FIG. 2B is a partial sectional view showing a cross-section of the disposable spittoon cover, according to an alternative embodiment wherein each groove of the multi-groove feature is separated by a step from a neighboring groove.

FIG. 2C is a partial sectional view showing a cross-section of the disposable spittoon cover, according to an alternative embodiment wherein larger-diameter grooves of the multi-groove feature are above or horizontal to a smallest-diameter groove placed at the base of the conical tunnel.

FIG. 4 is a plan view of the disposable spittoon cover shown in FIG. 1.

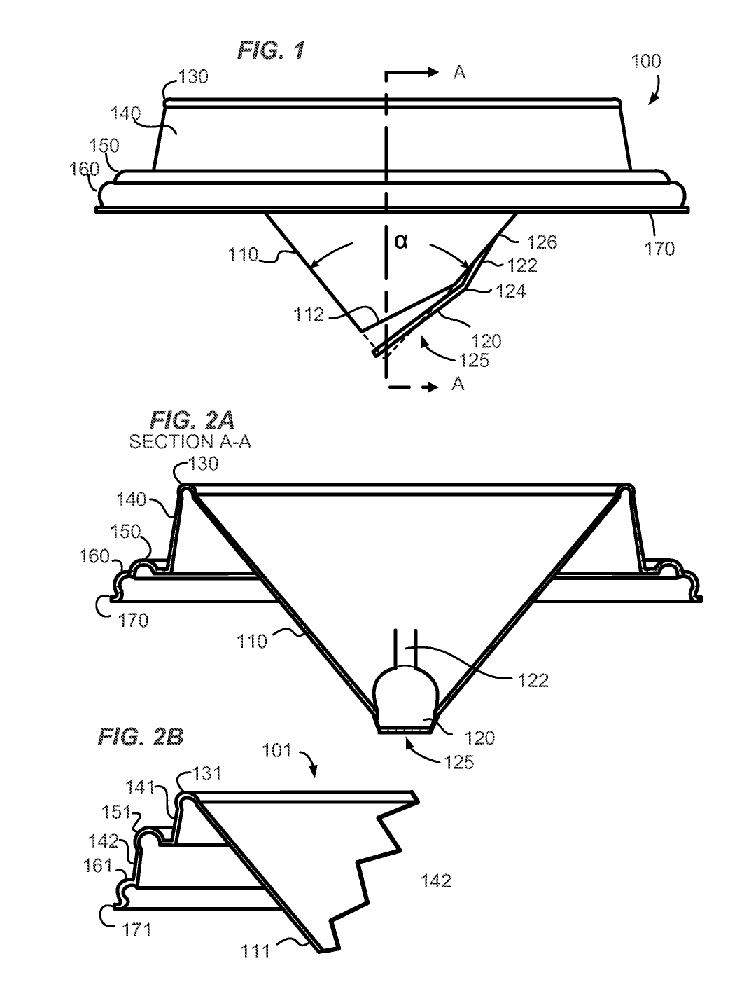

FIG. 3 is an isometric view of the disposable spittoon cover shown in FIG. 1.

FIG. 5 is a side, partial sectional view showing the disposable spittoon cover of FIG. 1 in use with different sizes of paper cup, as a spittoon.

FIG. 6 is an isometric view of a disposable spittoon cover, according to an alternative design, for fitting to a single size of cup.

FIGS. 7 and 8 are side views of the spittoon cover shown in FIG. 6.

FIG. 9 is an isometric view of a disposable spittoon cover according to an alternative design similar to that shown in FIG. 6, but with a fluted conical tunnel.

FIG. 10 is a plan view of the spittoon cover shown in FIG. 9.

FIG. 11 is an isometric view of a disposable cup cover incorporating a multi-groove feature, for a drinking cup or the like, with a generally flat cover portion.

FIG. 12 is an isometric view of a disposable cup cover incorporating a multi-groove feature, for a drink with topping, according to an alternative design with a convex-upward dome.

### DETAILED DESCRIPTION

The present disclosure describes a disposable spittoon cover for a paper cup or the like, with a conical tunnel having an entry hole for admitting waste fluids near or at an apex of the tunnel, and an integral, resilient flap covering the entry hole. The flap may be formed at a slight angle to the tunnel walls, in the range of about 5° to 20°, and at an oblique angle to the conical base plane of the tunnel. The disposable cover may further include two or more concentric grooves configured for fitting snugly to rims of disposable cups, with each of the grooves configured to fit to a cup of different diameter. The grooves may be separated and spaced apart from one another in a direct transverse to a plane defined by any one of the circular grooves (e.g., a “vertical” direction), by one or more interposed annular ring walls. As used herein, “up” or “upwards” and “down” or “downwards” should be understood with reference to side views in the drawings, for example, FIGS. 1, 2A and 5, wherein “up” is towards the top of the page and “down” towards the bottom of the page.

Referring generally to FIGS. 1, 2A, 3 and 4, a disposable spittoon cover 100 may include a contoured, resilient sheet material of formed of one piece, for example using a vacuum thermoforming process to mold a stock sheet material over a die. The cover 100 thus formed may include contours defining various cooperating components. These components may include a circular groove 160 disposed around and adjacent to a circular perimeter 170 of the sheet material. The groove 160 is concave towards a downwards side of the sheet material (towards the perimeter 170), and is configured to fit snugly over the rim of a disposable cup. For example, the groove 160 may be 94 mm (3.70 in) in diameter for fitting over a standard large size soda cup.

The components may further include a cone-shaped tunnel, also referred to as a conical tunnel 110, disposed at a circular center of the sheet material. The tunnel 110 may include an open conical base oriented towards an upwards side of the sheet material opposite to the downwards side. That is, the open conical base of the tunnel 110 faces upwards to receive waste fluids when the cover 100 is fit on to a disposable cup 102, as shown in FIG. 5. The components may further include a flap 125 positioned over a conical vertex of the tunnel 110. The flap 125 may be defined by a perimeter cut 112 through a lateral surface wall of the tunnel 110 and joined to the lateral surface wall by a resilient hinge piece 122 that is attached to the tunnel 110 at joint 126. The flap 125 operates to admit fluids into an attached cup, but otherwise remains closed during use to maintain a more attractive appearance, control odors, and reduce access by insects.

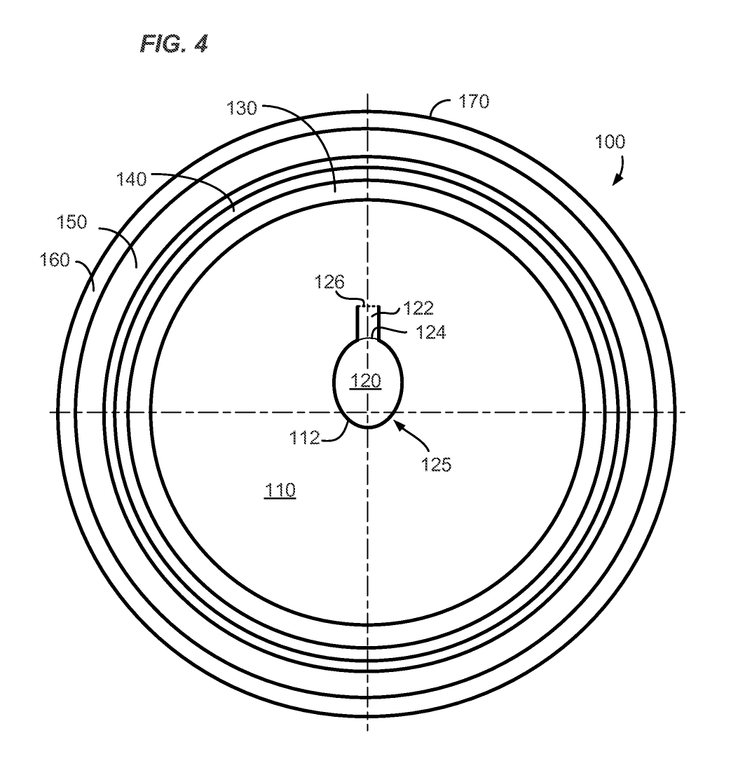

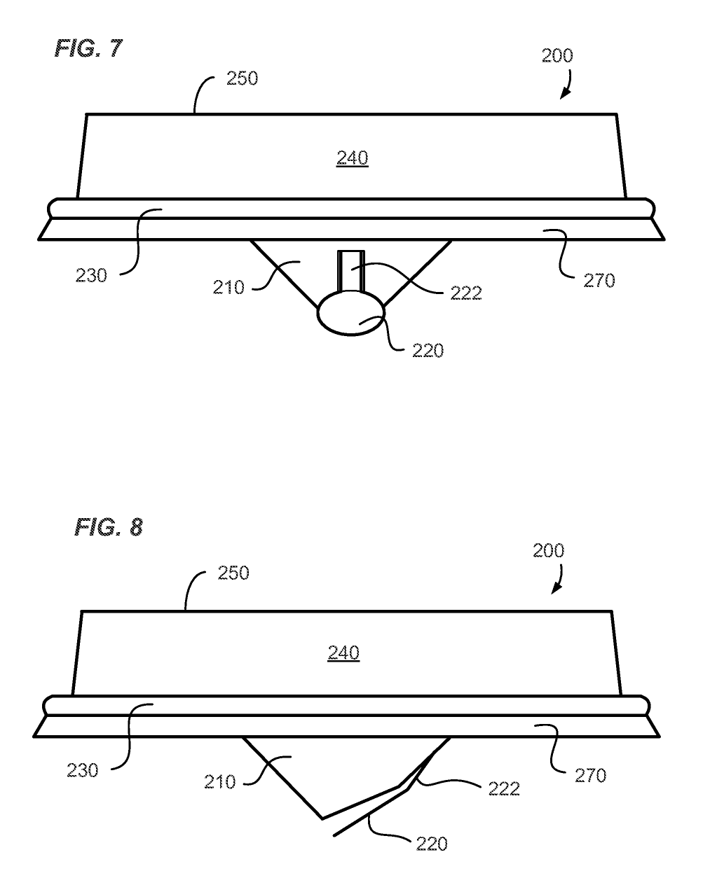

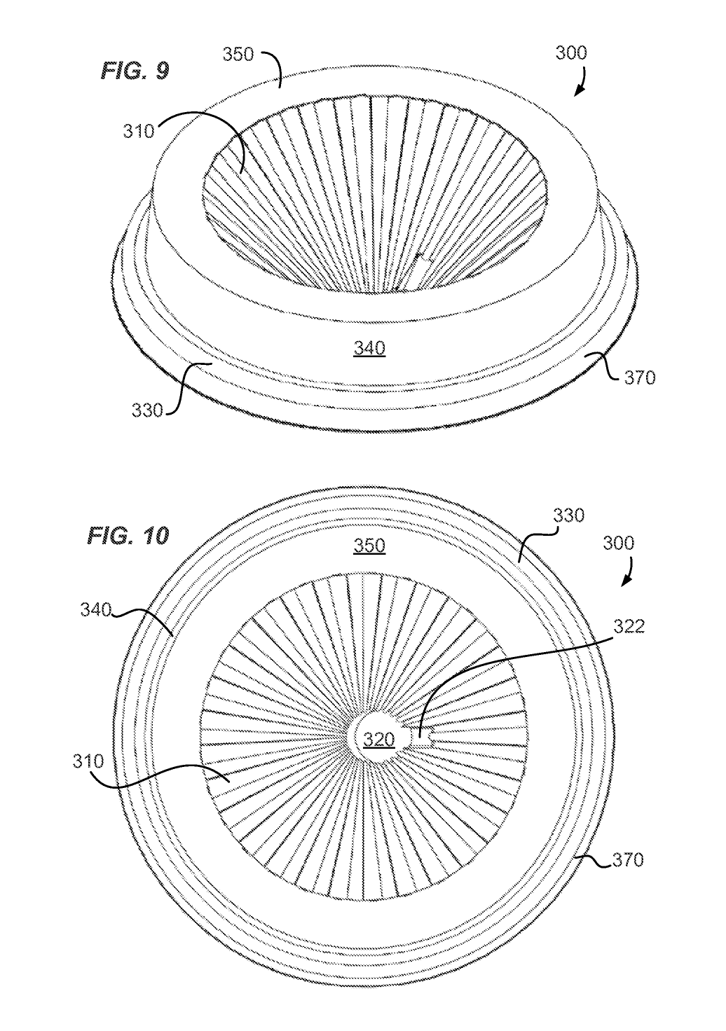

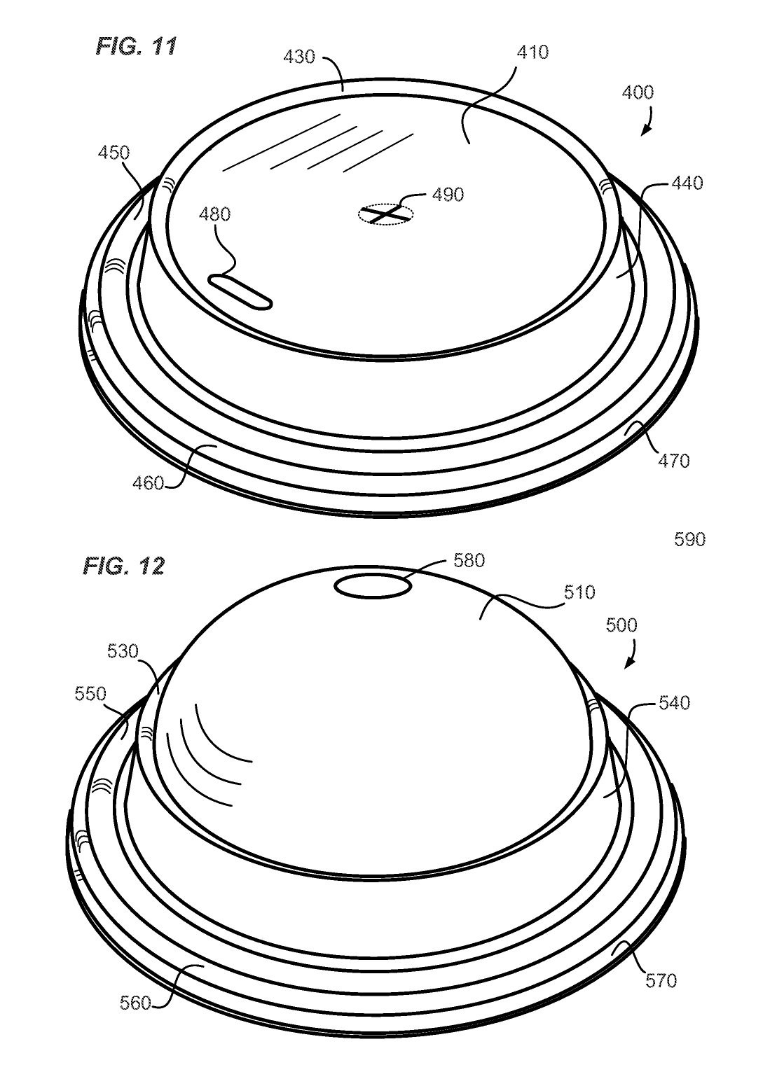

The flap 125 may be biased away from the circular center of the cover 100, where the apex of the conical tunnel lies. This is shown most clearly in FIG. 4. The flap 125 may include a generally elliptical planar body 120 joined to the hinge 122 at a fold 124. The fold 124 may define a small angle to the tunnel walls, for example at an angle in the range of about 5° to 30°. Thus, the planar body 120 of the flap 125 may be oriented obliquely to a conical base defined by the conical tunnel 110. For example, for an α=60° included angle cone with tunnel walls inclined at 60° to its base (FIG. 1), the planar body may be oriented at 45° to the conical tunnel base. The flap body 120 and hinge 122 may be formed by cutting with a die from the wall of the conical tunnel 110. The flap 125 is operative to admit, under influence of gravity, a fluid deposited in the cone-shaped tunnel through an opening in the sheet material formed by the perimeter cut of the flap. The bias in position of the flap 125 along with its oblique angle relative to the base of the conical tunnel 110 may facilitate its function for admitting fluids.

In an aspect, the flap body 120 and hinge 122 may be cut using a single integrated vacuum thermo-forming operation. In an alternative, the flap 125 may be cut in an operation separate from forming the sheet material. First, thermo-forming may be used to form a pad truncating the conical tunnel over a conical vertex thereof, biased away from the circular center of the sheet material and oriented obliquely to a conical base defined by the conical tunnel. The pad may be co-extensive with the flap body 120, and molded at the chosen oblique angle to the base of the tunnel 110. Then, the pad may be cut from the remainder of the cover using a separate die-cutting operation, except for a hinge portion that remains attached to the conical tunnel.

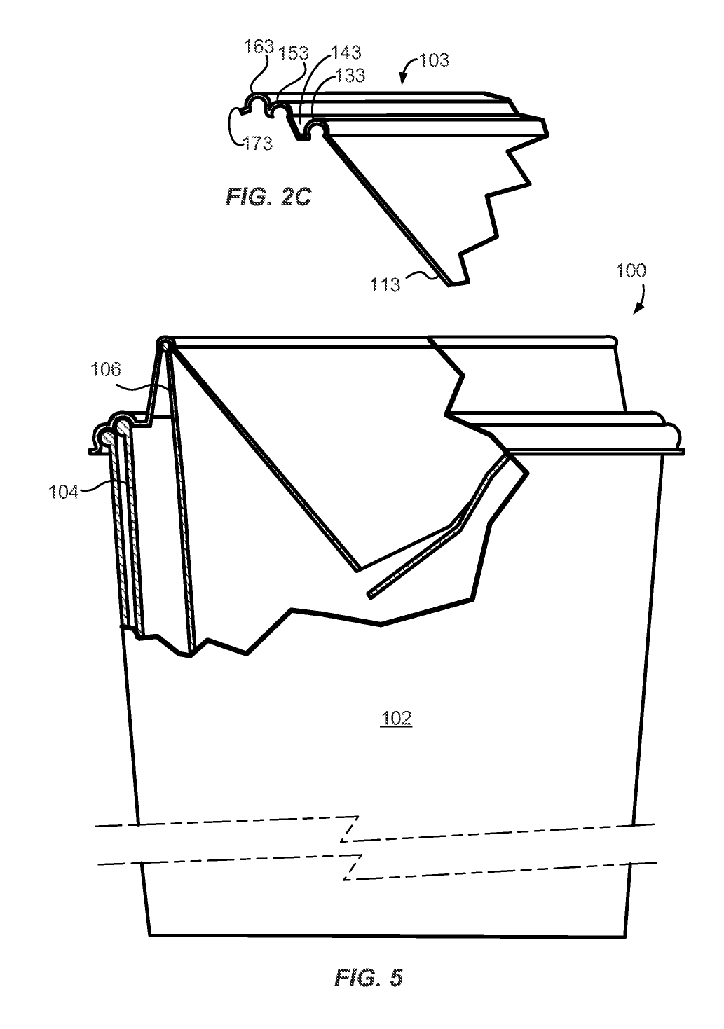

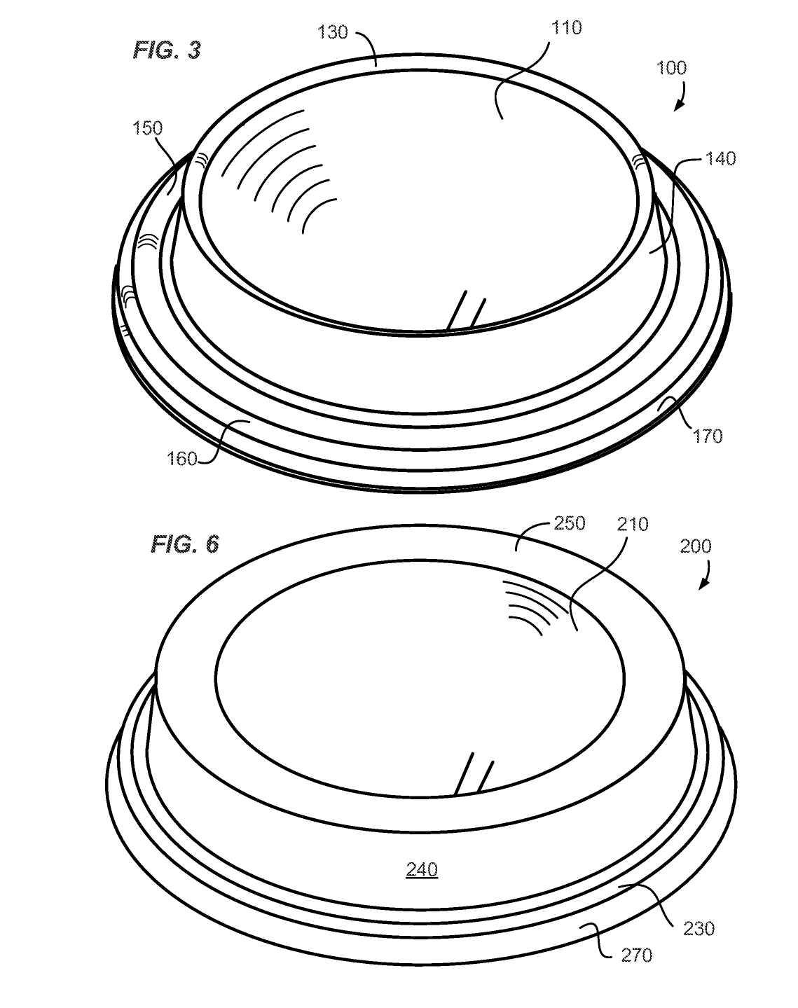

The circular groove 160 may have a cross-section contoured for fitting over a bead around a rim of a container, such as a disposable cup. For example, the cross-section may be generally semi-circular and narrowed at an open end thereof, as shown in FIG. 2A. The contours of the cover 100 may further define one or more additional circular grooves 130, 150 disposed between the circular periphery 170 of the sheet material and the first circular groove 160, each configured for fitting a cup of different diameter 102, 104, 106 than other ones of the grooves. In an embodiment, one of the additional circular grooves 130 runs around the open conical base of the tunnel, positioned at the terminus of the conical base. A second one of the additional circular grooves 150 may be disposed in the annular wall intermediate between the groove 130 positioned at the terminus of the conical base and the circular groove 160 adjacent to the periphery of the cover.

Each of the grooves 130, 150, 160 may have any dimensions and shape suitable for fitting snugly to the rim of a disposable cup, with each groove designed to fit a cup of different diameter. For example, the grooves 130, 150 and 160 may be concentric and of respective diameters as follows. The innermost groove 130 may have an outside diameter of 74 mm (2.91 in) for fitting a standard small size soda cup. The intermediate groove 150 may have an outside diameter of 89 mm (3.50 in) for fitting a medium size soda cup. The outermost groove 160 may have an outside diameter of 94 mm (3.70 in) for fitting a large size soda cup. Various different groove shapes and dimensions are known in the art, for fitting commonly-available types of disposable cup.

Contours of the cover 100 may further define an annular wall 140 extending between and around the open base of the cone-shaped tunnel 110 and the circular groove, providing substantial vertical separation between the base and the groove. The wall 140 may be used to raise the base of the tunnel 110 above the groove 150 by a substantial amount up to about one-half the length of the tunnel 110. For example, the wall 140 may be in the range of 0.5 and 2.0 inches high, such as 1.0 inch, for a cover of typical size. As shown in FIG. 2B, in an alternative cover 101, the annular wall may be divided into separate annular walls 141, 142, forming a stair step arrangement wherein an outermost groove 161 is located adjacent to the periphery 171, an intermediate groove 151 is located at the top of the first annular wall 142, and the innermost groove 130 bridges the top of the second annular wall 141 and the tunnel 111. Other aspects of the cover 101 may be like the earlier-described cover 100.

In alternative embodiments, as shown in FIG. 2C for an alternative cover 103, an annular wall 143 may be oriented upwards from an innermost groove 133 attached at an upper rim of a tunnel 113, bridging to an intermediate groove 153. An outermost groove 163 may be joined just outside and upwards of the intermediate groove 153. The arrangement shown in FIG. 2C may thus effectively extend the conical tunnel 113 up to the outermost groove 163, albeit with concentric ridges from the inwardly-located grooves 133, 153. Other aspects of the cover 103 may be like the earlier-described cover 100.

A sheet material used to form the cover 100 as a single piece may consist essentially of an organic polymer material. The organic polymer material may be characterized by a uniform thickness on the range of 0.004 to 0.040 inches, depending on qualities of the selected structural material. The organic polymer material may be, or may include, one or more of polystyrene, polyvinylchloride, or polyethylene, or other suitable polymer material. In alternative embodiments, the sheet material may comprise a paper or cardboard material, for example, waxed cardstock. The material configuration should be rigid enough to provide structural integrity and resiliency to the flap and grooves, while being as thin as possible for disposability and low cost. In embodiments, the sheet material may be a stock plastic material used in the manufacture of coffee cup lids or the like, for example, a 0.020 inch thick high impact styrene sheet.

Referring to FIG. 5, a disposable spittoon may be provided by covering a disposable cup 102 having a top opening defined by a sidewall, the sidewall connected to a circular bottom of the cup, with a disposable spittoon cover 100. The disposable cup may be, for example, a paper cup, a plastic cup, or an expanded polystyrene cup. The spittoon so provided may provide for low cost, sanitary disposal of waste fluids in a variety of social settings, while providing an improved appearance, accommodation for different sizes of cups using a single cover size, and improved control of odors and insects.

Referring to FIGS. 6-8, an alternative disposable spittoon cover 200 in a single-groove style for fitting to only one size of cup is shown. The cover 200 may include a tunnel 210 and flap 220 with hinge 222 similar to the tunnel 110 and flap 125 of the cover 100 described above. The cover 200 may include a single groove 230 for fitting to a specified size of cup adjacent to a perimeter 270 of the cover 200. A vertical wall 240 may elevate the tunnel 210 above the groove 230, and a horizontal ring 250 may join the tunnel 210 to the wall 240. Other aspects of the cover 200 may be the same as, or similar to, the earlier-described cover 100.

Referring to FIGS. 9-10, another alternative spittoon cover 300 is shown, also in a single-groove style. The cover 300 may include a fluted tunnel 310 and flap 320 with hinge piece 322 similar to the tunnel 110 and flap 125 of the cover 100 described above. The fluting impressed into the tunnel 310 may be primarily for ornamental or decorative purposes. A vertical wall 340 may elevate the tunnel 310 above the groove 330, and a horizontal ring or bridge 350 may join the tunnel 310 to the wall 340. Other ornamental patterns may also be molded into the cover 300, for example in the tunnel 310, wall 340, or bridge 350. The bridge 350, being visible from the top while in use, may be especially suitable for placing branding or other messaging. The cover 300 may include a single groove 330 for fitting to a specified size of cup adjacent to a perimeter 370 of the cover 300. Other aspects of the cover 300 may be the same as, or similar to, the earlier-described cover 100.

Referring to FIG. 11, the multi-groove feature of the spittoon cover may be adapted for use with other applications, such as for a drinking cup lid 400. The lid 400 may include multiple grooves 430, 440 and 450 arranged and configured similarly to the grooves described above in connection with the disposable spittoon cover 100, between a circular perimeter 470 and an innermost groove 430, for fitting a variety of sizes of disposable cups. An interior of the innermost groove may be filled by a generally flat cover 410, which may include various features known and used for flat drinking cup lids, for example, one or more through holes 480, 490. The lid 400 lacks a tunnel feature but may include an annular wall 440 to raise the cover 410 above the periphery 470, which can be useful for hot beverage containers designed for sipping and spill containment. Other aspects of the cover 400 may be the same as, or similar to, the earlier-described cover 100.

Referring to FIG. 12, yet another drinking lid 500 is shown with a multi-groove feature for fitting a variety of sizes of disposable cups. The lid 500 may include multiple grooves 530, 540 and 550 arranged and configured similarly to the grooves described above in connection with the disposable spittoon cover 100, between a circular perimeter 570 and an innermost groove 530. An interior of the innermost groove may be filled by a domed cover 510, which may include various features known and used for domed cup lids, for example, one or more through holes 580. The lid 500 lacks a tunnel feature or flap, but may include an annular wall 540 to raise the cover 510 above the periphery 570, which can be useful for creamed or frozen beverage containers designed for attractive display of a contained treat at the time of serving “to go.” Other aspects of the cover 500 may be the same as, or similar to, the earlier-described cover 100.

Accordingly, disposable spittoon covers, disposable spittoons, and other disposable covers of various designs including a multi-groove feature are disclosed. The previous description of the disclosure is provided to enable any person skilled in the art to make or use the novel subject matter disclosed therein. Various modifications to the disclosure will be readily apparent to those skilled in the art, and the generic principles described herein may be applied to other variations without departing from the spirit or scope of the disclosure. Thus, the disclosure is not intended to be limited to the examples and designs described herein but should be accorded the widest scope consistent with the principles and novel features disclosed herein.

What is claimed is:

1. A cover for a container, consisting essentially of a contoured, resilient sheet material of one piece having contours defining:
a circular groove disposed around and adjacent to a circular periphery of the sheet material, the groove concave towards a first side of the sheet material;
a conical tunnel disposed at a circular center of the sheet material, having an open conical base oriented towards a second side of the sheet material opposite to the first side; and
a flap over a conical vertex of the conical tunnel, the flap defined by a perimeter cut through a lateral surface wall of the conical tunnel and joined to the lateral surface wall by a resilient hinge piece.

2. The cover of claim 1, wherein the contours further define an annular wall extending between and around the open conical base of the conical tunnel and the circular groove.

3. The cover of claim 1, wherein the circular groove has a cross-section contoured for fitting over a bead around a rim of a container, the cross-section narrowed at an open end thereof.

4. The cover of claim 3, wherein the cross-section of the circular groove includes a semi-circular portion.

5. The cover of claim 1, wherein the contours further define a second circular groove disposed between the circular periphery of the sheet material and the circular groove.

6. The cover of claim 1, wherein the flap is biased away from the circular center of the sheet material.

7. The cover of claim 6, wherein the flap comprises a substantially planar body joined to the hinge.

8. The cover of claim 7, wherein the substantially planar body of the flap is oriented obliquely to a conical base defined by the conical tunnel.

9. The cover of claim 1, wherein the flap is operative to admit, under influence of gravity, a fluid deposited in the conical tunnel through an opening in the sheet material formed by the perimeter cut of the flap.

10. The cover of claim 1, wherein the sheet material consists essentially of an organic polymer material.

11. The cover of claim 10, wherein the organic polymer material is characterized by a uniform thickness on the range of 0.004 to 0.040 inches.

12. The cover of claim 11, wherein the organic polymer material comprises a plastic selected from the group consisting of: polystyrene, polyvinylchloride, polyethylene, paper, or cardboard.

13. A cover for a container, consisting essentially of a contoured, resilient sheet material of one piece having contours defining:
a circular groove disposed around and adjacent to a circular periphery of the sheet material, the groove concave towards a first side of the sheet material;
a conical tunnel disposed at a circular center of the sheet material, having an open conical base oriented towards a second side of the sheet material opposite to the first side and a through hole located at a conical vertex; and
a pad truncating the conical tunnel over a conical vertex thereof, biased away from the circular center of the sheet material and oriented obliquely to a conical base defined by the conical tunnel.

14. A cover for a container, consisting essentially of a contoured, resilient sheet material of one piece having contours defining:
a first circular groove disposed around and adjacent to a circular periphery of the sheet material, the first circular groove having a first diameter and being concave towards a first side of the sheet material configured for fitting snugly over a rim of a disposable cup of matching diameter;
a second circular groove disposed in the sheet material concentric to the first circular groove, the second circular groove having a second diameter smaller than the first diameter and being concave towards the first side of the sheet material configured for fitting snugly over a rim of a disposable cup of matching diameter; and
a cover comprised of the sheet matter closing an interior of the second circular groove.

15. The cover of claim 14, further comprising an annular wall formed in the sheet material and interposed between first circular groove and the second circular groove, thereby spacing the first circular groove apart from the second circular groove in a direction perpendicular to a plane defined by the first circular groove.

16. The cover of claim 14, wherein the cover is contoured in a configuration selected from: a dome concave towards the first side of the sheet material, a flat sheet, or a cone opening away from the first side of the sheet material.

17. The cover of claim 14, further comprising a third circular groove disposed in the sheet material concentric to and inward of the first circular groove, the third circular groove having a third diameter smaller than the first diameter and larger than the second diameter, and being concave towards the first side of the sheet material configured for fitting snugly over a rim of a disposable cup of matching diameter.

18. A spittoon, comprising:
a disposable cup having a top opening defined by a sidewall, the sidewall connected to a circular bottom of the cup;
a cover fitted over the cup around the top opening, the cover consisting essentially of a contoured, resilient sheet material of one piece having contours defining a conical tunnel disposed at a circular center of the sheet material, having an open conical base proximal to the top of the disposable cup and a vertex proximal to the bottom of the cup; and
a flap at a bottom of the conical tunnel, the flap defined by a perimeter cut through a lateral surface wall of the conical tunnel and joined to the lateral surface wall by a resilient hinge piece.

19. The spittoon of claim 18, wherein the contours further define a circular groove around a periphery of the cover, the groove contoured for fitting over a rim around the top opening.

20. The spittoon of claim 18, wherein the flap is biased away from the circular center of the sheet material.

21. The spittoon of claim 20, wherein the flap comprises a substantially planar body joined to the hinge.

22. The spittoon of claim 21, wherein the substantially planar body of the flap is oriented obliquely to a conical base defined by the conical tunnel.

23. The spittoon of claim 18, wherein the flap is operative to admit, under influence of gravity, a fluid deposited in the conical tunnel through an opening in the sheet material formed by the perimeter cut of the flap into the cup.

24. The spittoon of claim 18, wherein the disposable cup comprises one of a paper cup, a plastic cup, or an expanded polystyrene cup.
